(19) United States
(12) Patent Application Publication
(10) Pub. No.: US 2018/0079623 A1
(43) Pub. Date: Mar. 22, 2018

(54) BRAKE DEVICE FOR A CAR OF AN ELEVATOR SYSTEM

(71) Applicants: THYSSENKRUPP ELEVATOR AG, Essen (DE); thyssenkrupp AG, Essen (DE)

(72) Inventor: Eduard STEINHAUER, Nürtingen (DE)

(73) Assignees: THYSSENKRUPP ELEVATOR AG, Essen (DE); thyssenkrupp AG, Essen (DE)

(21) Appl. No.: 15/554,244

(22) PCT Filed: Mar. 2, 2016
(86) PCT No.: PCT/EP2016/054415

§ 371 Date: Aug. 29, 2017

(30) Foreign Application Priority Data
Mar. 3, 2015 (DE) 10 2015 103 012.8

(51) Int. Cl. B66B 5/16; B66B 9/00

(52) U.S. Cl. CPC B66B 5/16; B66B 9/003

(57) ABSTRACT

A brake device can brake a car of an elevator system in which the car is horizontally displaceable along a horizontal guide rail. The brake device is designed to brake a horizontal movement of the car in a first movement direction. The brake device, prior to a braking action of the horizontal movement of the car, may be disposed in a defined rest position relative to the horizontal guide rail. The brake device may be designed to be deflected into a deflected position during the braking action of the horizontal movement of the car. The brake device may comprise a reset device that is designed to reset the brake device from the deflected position into the rest position following the braking action of the car.

The present invention relates to a brake device for a car of an elevator system and to a corresponding elevator system. The car can be displaced horizontally along a guide rail. The brake device is designed to brake a horizontal movement of the car in a first movement direction.

### PRIOR ART

Brakes on a car for vertically displaceable cars in elevator systems are generally merely unidirectional. Such unidirectional brakes are generally arranged on the car itself and can brake only a movement of the car in a specific movement direction, generally only a movement of the car in the downward direction. Such a brake for movements of the car in the downward direction is generally required for the sole purpose of being able to prevent the car from possibly plunging downward in an emergency situation.

In modern elevator systems, it is often the case that cars can be displaced not just vertically, but also horizontally. In this way, it is possible to allow, for example, for cars to change over between adjacent, vertically extending elevator shafts. Brake devices which are provided for the vertical movement of the car are generally also used here for the horizontal movement of the car.

Such cars which can be displaced both horizontally and vertically may be designed, for example, in the form of rope-free cars, that is to say ones which are in particular not connected to a counterweight.

Unidirectional brakes may be provided for the vertical displacement of such cars. Movement of the car in the upward direction can generally be prevented automatically by virtue of the corresponding motor being switched off. There is therefore no need for an additional braking action of a brake for such movement in the upward direction. Furthermore, it may often also be the case that braking of the car during movement in the upward direction is undesirable on account of certain safety aspects since abrupt deceleration of the upward movement of the car could result in passengers' heads striking against the ceiling of the car.

A unidirectional brake which acts in just one movement direction during vertical movement of the car consequently also acts in just one movement direction, for example only to the left or only to the right, during horizontal movement of the car. During horizontal movement of the car, however, it is necessary for it to be possible to brake movement of the car in both movement directions, so as to avoid the situation where the car collides for example with the wall of the elevator shaft.

It is therefore desirable to provide an improved brake device for a horizontally displaceable car of an elevator system.

### DISCLOSURE OF THE INVENTION

This object is achieved by a brake device for a car of an elevator system, and by a corresponding elevator system, having the features of the independent patent claims. Advantageous embodiments form the subject matter of the dependent claims and of the description which follows.

The car of the elevator system can be displaced horizontally along a guide rail. The brake device is designed to brake a horizontal movement of the car in a first movement direction. The brake device, prior to a braking action of the horizontal movement of the car, is arranged in a defined rest position in relation to the horizontal guide rail. The brake device is designed to be deflected into a deflected position during the braking action of the horizontal movement of the car. The brake device comprises a reset device, which is designed to reset the brake device from the deflected position into the rest position following the braking action of the car.

The brake device can brake the horizontal movement of the car without any additional brake device which may possibly be arranged on the car itself having to be actuated.

The guide rail is arranged, in particular, in an elevator shaft in which the car can be displaced horizontally. More particularly, the car can be displaced between two vertical elevator shafts during the course of the horizontal movement. In this case, the guide rail may be arranged, for example, between said two vertical elevator shafts. In particular, the car can be displaced both vertically and horizontally.

According to the invention, the brake device is not arranged on the car itself. Accordingly, the brake device does not accompany the movement of the car. The brake device is arranged, in particular, on the guide rail. More particularly, the brake device may be arranged on a further rail, for example on a braking rail, which extends in particular parallel to the guide rail. In particular, the brake device in its defined rest position is fixed relative to the elevator system and/or relative to the guide rail.

The brake device is arranged relative to the car in particular such that, during the course of its horizontal movement in the first movement direction, the car moves toward the brake device. In particular, the horizontal movement of the car in the first movement direction is delimited by the brake device. In particular, the brake device is arranged at a position at which braking of the movement of the car should begin.

The car comes into contact with the brake device during the course of its horizontal movement. The brake device absorbs kinetic energy from the car and converts it into a different form of energy, for example into frictional heat. The brake device brakes the horizontal movement of the car and applies a corresponding braking action to the horizontal movement. During the course of this, the brake device is deflected from its defined rest position into a deflected position. This deflected position can vary in dependence on the speed and loading of the car.

Following the braking action of the car, the brake device is moved back from the deflected position into its defined rest position again by the reset device. In particular, this resetting operation of the brake device is carried out once the car has been moved away again. This ensures that the brake device is arranged in the defined rest position again for the next braking operation of the car.

The invention provides a brake device which, during horizontal movement of the car, provides for a braking action in an expedient horizontal movement direction of the car. Depending on where the brake device is arranged in relation to the horizontal guide rail and/or in relation to the car, it is possible to provide for a braking action in a movement direction to the left or to the right.

The brake device need not be arranged on the car itself. There is no need for the car to be converted in any way. The brake device can be arranged in the elevator system in a straightforward manner, without any degree of complexity. The brake device operates, in particular, independently of other components of the car or of the elevator system, in particular independently of components which are provided for any vertical movement of the car. In particular, the brake device does not influence such other components in any way.

In particular, the car may comprise an additional brake device, referred to hereinbelow as vertical brake device, which is provided for vertical movement of the car. This vertical brake device is, in particular, unidirectional and applies in particular only a braking action to a vertical movement of the car in the downward direction. During horizontal movement of the car, said vertical brake device, in particular, applies likewise only a braking action in one movement direction, for example only to the left or only to the right. The invention can make it possible for the car, even during horizontal movement, to be braked in that movement direction in which the unidirectional vertical brake device on the car does not act during horizontal movement. Optimum interaction between a horizontal brake device according to the invention and a unidirectional vertical brake device can be made possible.

The operation of the brake device being reset by the reset device is carried out in particular automatically. This resetting of the brake device can be carried out, for example, immediately once the deflected position has been reached or, in particular, a certain amount of time after the deflected position has been reached. In particular, it is likewise possible for the car to be moved along as well by the resetting operation. As an alternative, it is also possible for the resetting operation to be carried out only once the car has been moved away again.

The brake device advantageously comprises a braking element which applies a force to a braking rail. In particular, the brake device applies this force permanently to the braking rail, even when the car is not being braked. It is thus possible to ensure that the brake device is ready to brake the car at all times. For example, the braking element may comprise one or more brake blocks, which can each be pressed against the braking rail by said force. Said braking element can generate a braking force which acts in a direction counter to the first movement direction of the car. For the purpose of braking the car, therefore, in particular the normal force is converted into a braking force. More particularly, kinetic energy of the car is converted into thermal energy, e.g. by way of frictional heat, in this way during the course of the braking action.

The braking rail can be provided by the guide rail itself or by a further rail, which is separate from the guide rail.

The braking rail extends in particular parallel to the guide rail. More particularly, it is possible for the braking rail to be arranged on the guide rail or to be connected thereto. In particular, it is also possible for the guide rail and the braking rail to be designed in the form of a single rail, in which case the braking element applies the braking force in particular to the guide rail.

The braking element is preferably designed in the form of a mechanical and/or in the form of an electromagnetic braking element. An electromagnetic braking element may be designed, for example, in the form of an eddy-current brake.

The braking element preferably comprises at least one energy-storage element, in particular at least one spring element. Such energy-storage elements cause the braking element to apply, in particular, a necessary force to the braking rail. More particularly, brake blocks are pressed against the braking rail with the corresponding necessary force by said energy-storage elements.

The reset device advantageously comprises a brake-release device for releasing the brake device, in particular for releasing the braking element. This release action eliminates or suppresses, in particular, the braking action of the brake device. It is thus possible to move the brake device without the braking action having to be counteracted. This makes it possible for the brake device to be moved back into the defined rest position in a straightforward manner, without any degree of complexity.

In particular, the brake-release device releases the brake device once the latter has reached the deflected position. The brake device is then moved, in particular, back into the defined rest position by the reset device. Once the rest position has been reached, the action of the brake device being released is terminated again.

The reset device preferably comprises at least one motor and/or at least one actuator for moving the brake device horizontally. These motors and/or these actuators can move the brake device, in particular, from the deflected position back into the defined rest position. In particular, these motors and/or actuators are correspondingly activated when the brake device is released by the brake-release device.

The brake device preferably comprises a control unit for controlling the resetting operation of the brake device. In particular, this control unit monitors a position of the brake device. For this purpose, the control unit may be connected, in particular, to expedient position sensors. If the position of the brake device deviates from the defined rest position, the reset device is correspondingly activated by the control unit in order to reset the brake device into the rest position. In particular, the control unit can regulate and/or control the position of the brake device.

The brake device preferably comprises at least one position sensor for determining the position of the brake device. As explained above, this position sensor may be connected, in particular, to the control unit.

The brake device advantageously comprises a bumper element. In particular, the bumper element may be designed in the form of a main body of the brake device. In particular, the bumper element absorbs the kinetic energy from the car. More particularly, this kinetic energy is transmitted to the braking elements by the bumper element.

A buffer element is preferably arranged at a car end of the brake device. The car end of the brake device should be understood here to be an end or a side of the brake device which is directed toward the car and with which the car comes into contact during the course of its horizontal movement. This buffer element is capable of reducing, or even of eliminating, in particular an energy peak as the car comes into contact with, or makes impact with, the brake device. This means that the contact of the car with the brake device can be as smooth and damped as possible. In particular, the buffer element ensures that the braking action of the car is as jolt-free as possible. Travelling comfort is therefore not impaired and there are no noises or movements to annoy passengers within the car.

The brake device is advantageously arranged at one end of the guide rail. In particular, the horizontal movement of the car is delimited in this way. In particular, it is thus possible to prevent the situation where the car collides for example with a wall on which the guide rail is arranged.

The invention also relates to an elevator system. Embodiments of this elevator system according to the invention can be gathered in an analogous manner from the above description of the brake device according to the invention.

The elevator system according to the invention comprises a guide rail, also comprises a car which can be displaced horizontally along said guide rail, and further comprises at least one brake device according to the above description.

As explained above, the car can be displaced, in particular, both vertically and horizontally and may comprise, for example, a unidirectional vertical brake device.

In particular, the vertical brake device here applies a braking action in a second movement direction, which is directed counter to the first movement direction. The brake device according to the invention, nevertheless, can generate a braking action in the first movement direction during horizontal movement of the car. The brake device according to the invention operates autonomously and independently of the second brake device and does not have any negative or disruptive effect on the second brake device.

The elevator system advantageously comprises a first brake device and a second brake device. The first brake device is designed to brake a horizontal movement of the car in a first movement direction. The second brake device is designed to brake a horizontal movement of the car in a second movement direction. The first movement direction is directed counter to the second movement direction. It may thus be ensured that it is always possible to brake a horizontal movement of the car.

Said first and said second brake devices are preferably arranged at opposite ends of the guide rail. This makes it possible, in particular, for the car to move horizontally essentially along the entire length of the guide rail.

According to a preferred embodiment, the elevator system comprises a linear drive. The linear drive is designed to displace the car. The elevator system is thus designed, in particular, without a machine room. The car is displaced, in particular, in a rope-free manner, that is to say in particular without any suspension ropes. In particular, a first element of said linear drive is arranged on the guide rail. In particular, the said first element may be formed by the guide rail itself. A second element of the linear drive is arranged, in particular, on the car. Said first and said second elements of the linear drive interact with one another, as a result of which the car can be displaced. The first element may be designed, for example, in the form of a stator or primary part. It is possible here, in particular, for energized coils to be arranged, in the form of a stator, on the guide rail. The second element may be designed, for example, in the form of a reaction part or secondary part. In particular, at least one permanent magnet and/or at least one electromagnet are/is arranged, in the form of a reaction part, on the car. As an alternative, it is also possible for the second element, which is arranged on the car, to be designed in the form of a stator and for the first element to be designed in the form of a reaction part. Furthermore, it is also conceivable to embody the linear drive in the form of an asynchronous linear drive. An asynchronous linear drive is designed without permanent magnets or electromagnets.

In an advantageous embodiment, the elevator system comprises at least two vertically extending elevator shafts. The car can be displaced between two of these at least two vertically extending elevator shafts by means of a horizontal movement. Such an elevator system is described, and disclosed, in the applicant's DE 10 2014 104 458.4. Reference is hereby made to the entire content of said document. Accordingly, the elevator system according to the invention may preferably be embodied in the form of an elevator system according to DE 10 2014 104 458.4. The guide rail of the elevator system here corresponds, in particular, to a rail described in DE 10 2014 104 458.4.

In each case at least one rail, in particular a guide rail, along which the car can be displaced is arranged in each elevator shaft in such an elevator system. Each of the rails comprises at least one rotatably designed segment. These rotatable segments can be oriented in relation to one another such that the car can be displaced between the elevator shafts along the segments. The car can thus be displaced between the elevator shafts along rotated segments of two rails in adjacent elevator shafts. In particular, the segments are rotated through 90°. Rotation of the segments thus forms a horizontal rail along which the car is displaced horizontally.

In particular, the car here can be displaced along the rails in the elevator shafts by means of a linear drive or by means of a plurality of linear drives. A first element of the linear drive is formed, in particular, by the rails of the elevator shafts. A second element of the linear drive is mounted, in particular, in a rotatable manner on the car. In particular, the second element can be rotated with the segments of the rails. The second element of the linear drive can thus be rotated in a manner analogous to the first element of the linear drive and can be utilized for the horizontal displacement of the car.

Further advantages and embodiments of the invention can be gathered from the description and the accompanying drawing.

Of course, the features which have been mentioned above, and those which are yet to be explained hereinbelow, can be used not just in the combination specified in each case, but also in other combinations or on their own, without departing from the framework of the present invention.

The invention is illustrated schematically in the drawing by way of an exemplary embodiment and will be described hereinbelow with reference to the drawing.

### DESCRIPTION OF THE FIGURES

FIG. 1 shows, schematically, a preferred embodiment of an elevator system according to the invention.

FIG. 2 shows, schematically, a preferred embodiment of a brake device according to the invention in two operating states.

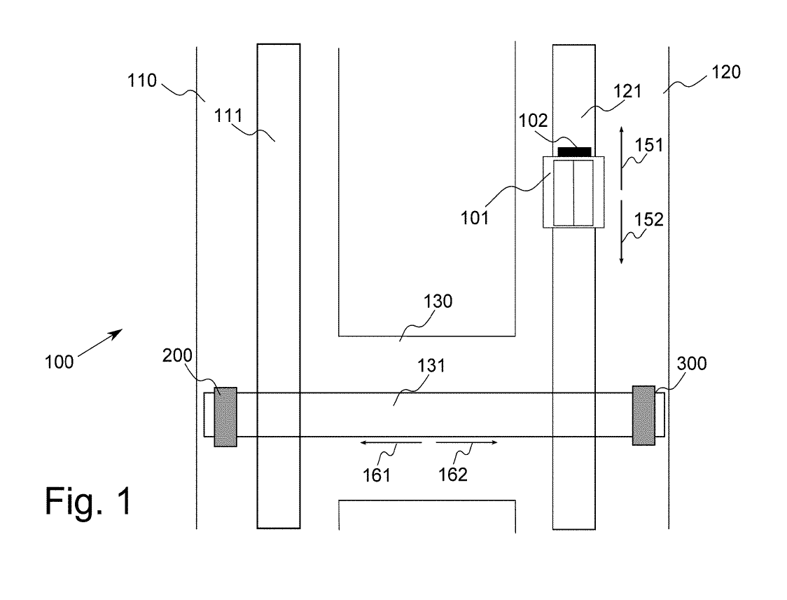

A preferred embodiment of an elevator system according to the invention is illustrated schematically, and designated by 100, in FIG. 1.

The elevator system 100 comprises two vertically extending elevator shafts 110 and 120. A vertical guide rail 111, 121 is arranged in each of these vertical elevator shafts 110 and 120, respectively.

A car 101 can be displaced vertically along these guide rails 111 and 121 in the respective vertical elevator shafts 110 and 120. The car 101 here can execute both a vertical movement in a first movement direction 151, in this example in the upward direction, and a vertical movement in a second movement direction 152, in this example in the downward direction.

The car 101 can change over between the vertical elevator shafts 110 and 120. A horizontal elevator shaft 130 is provided for this purpose, and connects the two vertical elevator shafts 110 and 120 to one another. A horizontal guide rail 131 is arranged in the horizontal elevator shaft 130.

The vertical elevator shafts 110, 120 and the horizontal elevator shaft 130 may also be designed in the form of a joint elevator shaft, in which for example two or more cars can be displaced one beside the other in the vertical direction.

The car 101 can be displaced horizontally along said horizontal guide rail 131. The car 101 here can execute both a horizontal movement in a first movement direction 161, in this example to the left, and a horizontal movement in a second movement direction 162, in this example to the right.

The elevator system 100 also comprises a linear drive. The car 101 is caused to execute an appropriate horizontal or vertical movement by said linear drive. The elevator system 100 is therefore designed in the form of an elevator system without a machine room. The car 101 is displaced in a rope-free manner, in particular without any suspension ropes.

A first element of said linear drive, for example a primary part such as, for example, energized coils, is arranged on each of the guide rails 111, 121 and 131. A second element, for example a secondary part, of said linear drive is arranged, in particular, on the car. Said second element is designed, for example, in the form of an arrangement of permanent magnets. For the sake of clarity, these elements of the linear drive have not been illustrated explicitly in FIG. 1.

A vertical brake device 102 is also arranged on the car. This vertical brake device 102 makes it possible to brake a movement of the car 101 in the downward direction 152. A vertical movement of the car 101 in the upward direction 151 is braked automatically when the linear drive is correspondingly activated or deactivated.

Said vertical brake device 102 has no effect during horizontal movement of the car 101 to the left 161 or to the right 162. The elevator system 100 therefore comprises a preferred embodiment of a brake device according to the invention at each of the opposite ends of the horizontal guide rail 131. A first such brake device 200 is provided to brake a horizontal movement of the car 101 to the left 161. A second brake device 300 is provided to brake a horizontal movement of the car 101 to the right 162.

Provision may also be made, in particular, for just one preferred embodiment of a brake device according to the invention to be arranged in the elevator system 100. If the vertical brake device 102 can brake, for example, just a horizontal movement of the car 101 to the right 162, it is possible, for example, for just the first brake device 200 to be arranged on the guide rail 131, in order to brake a horizontal movement of the car 101 to the left 161.

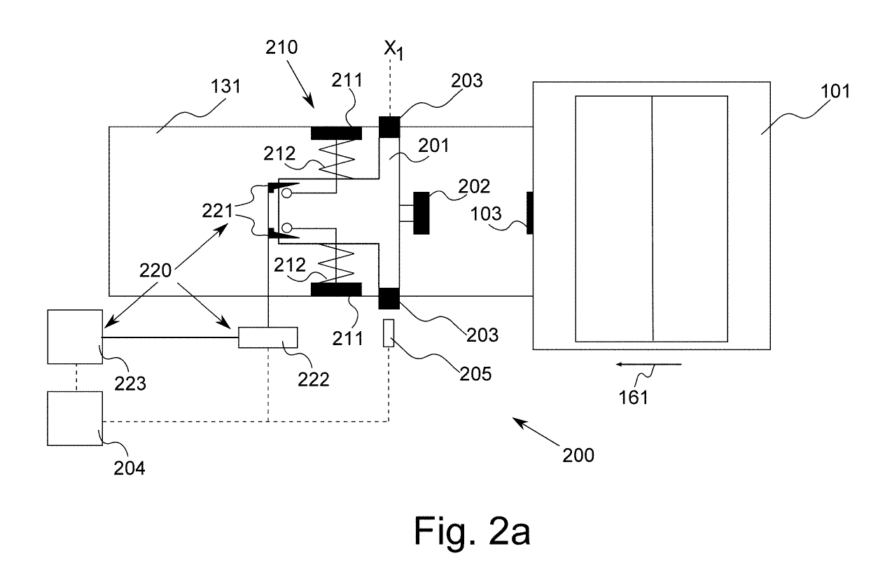

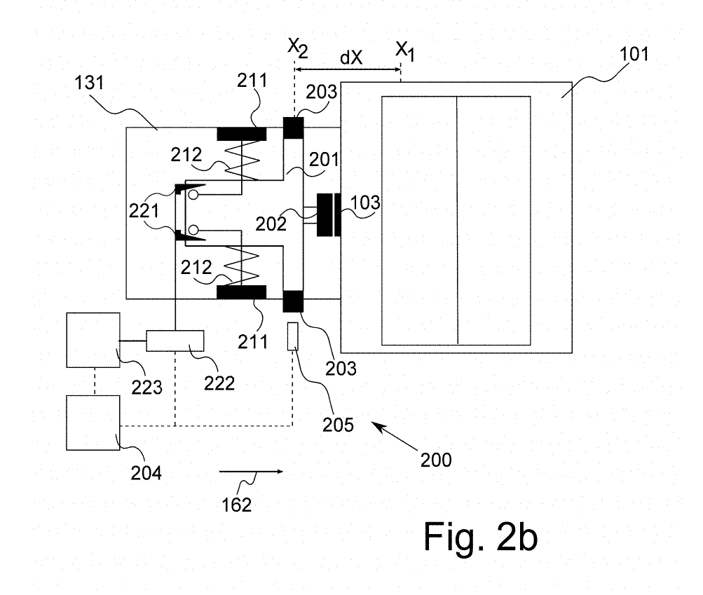

Such a preferred embodiment of the brake device according to the invention is illustrated schematically in FIG. 2.

FIG. 2 illustrates the first brake device 200 according to FIG. 1 schematically. The car 101 and the horizontal guide rail 131 are also illustrated.

FIG. 2a illustrates the car 101 during a horizontal movement to the left 161. The car 101 moves toward the brake device 200 during the course of this horizontal movement 161. The brake device 200 is designed to brake said horizontal movement to the left 161.

FIG. 2a illustrates the brake device 200 prior to said braking action of the movement 161. FIG. 2b illustrates the brake device 200 following said braking action of the movement 161, that is to say once the car 101 has been stopped.

In this example of FIG. 2, the brake device 200 is arranged on the horizontal guide rail 131. It is also possible, however, to provide a separate rail, for example a braking rail, on which the brake device 200 can be arranged.

As illustrated in FIG. 2a, the brake device 200, prior to the braking action, is arranged in a defined rest position X₁ in relation to the horizontal guide rail 131. As illustrated in FIG. 2b, the brake device 200, following the braking action, is arranged in a deflected position X₂ in relation to the horizontal guide rail 131.

During the course of the braking action, the brake device 200 is thus deflected in the direction of the first movement direction 161, that is to say to the left, by a distance dX from the rest position X₁ into the deflected position X₂.

The brake device 200 comprises a bumper element 201. The bumper element 201 is designed in the form of a main body of the brake device 200. A buffer element 202 is arranged at a car end of the brake device 200, which is directed toward the car 101, that is to say on the right-hand side of the brake device 200. In particular an impact element 103, for example an impact plate, is arranged on the car 101, on a side of the latter which is directed toward the brake device 200. When the car 101 comes into contact with the brake device 200, the impact element 103 comes into contact, in particular, with the buffer element 202. This allows the impact to be damped.

The brake device 200 comprises a guide element 203, for example a sliding-action guide. This guide element 203, in particular, ensures that the brake device 200 does not leave the guide rail 131.

The brake device 200 also comprises a braking element 210, which in this example is designed in the form of a mechanical braking element. The braking element 210 comprises two brake blocks 211 and two energy-storage elements 212 designed in the form of spring elements or springs. The springs 212 press the respective brake block 211 against the guide rail 131. The guide rail 131, in this example, functions as a braking rail, to which a force is applied by the braking element 210 and/or by the brake blocks 211.

When the car 101 in the rest position X₁ comes into contact with the brake device 200 and the brake device is deflected, the braking element 210 continues to apply a force to the guide rail 131. Kinetic energy from the car 101 is converted here, in particular by friction, into heat energy and the car 101 is braked.

Once the car 101 has been successfully braked and stopped, and the brake device 200 has been deflected into the deflected position X₂, the brake device 200 should be reset back into the rest position X₁. This resetting operation can be carried out, for example, as soon as the car has been moved away again.

A reset device 220 is provided for the operation of resetting the brake device 200. The reset device 220 comprises a brake-release device 221 for releasing the brake device, in particular for releasing the braking element 210. In this example, the brake-release device 221 comprises two wedges, which can be moved vertically. This vertical movement allows the springs 212 to be compressed. As a result, the brake blocks no longer apply any force to the guide rail 131.

In this example, the reset device 220 also comprises a reset element 222 and a motor 223. The reset element 222 is connected mechanically to the brake device. The motor 223 can move the reset element 222 horizontally, in particular in the second movement direction 162 to the right. The brake device 200 is moved to the right, and back into the rest position X₁, by said movement of the reset element 222 and by the mechanical connection between the reset element 222 and the brake device 200.

The brake device 200 also comprises a control unit 204. This control unit 204 is designed, in particular, to control the resetting of the brake device 200. For this purpose, the control unit 204 can expediently activate the individual elements of the reset device 220. This activation is indicated in FIG. 2 by dashed lines.

In particular, it is possible to provide a position sensor 205 which can determine the position of the brake device 200 relative to the guide rail 131. The position sensor 205 is connected, in particular, to the control unit 204. The position sensor 205 allows the control unit to control the resetting operation of the brake device 200.

### LIST OF REFERENCE SIGNS

100 Elevator system
101 Car
102 Vertical brake device
103 Impact element, impact plate
110 Vertical elevator shaft
111 Vertical guide rail
120 Vertical elevator shaft
121 Vertical guide rail
130 Horizontal elevator shaft
131 Horizontal guide rail
151 Vertical movement, movement in the upward direction
152 Vertical movement, movement in the downward direction
161 Horizontal movement, movement direction to the left
162 Horizontal movement, movement direction to the right
200 First brake device
300 Second brake device
201 Bumper element
202 Buffer element
203 Guide element, sliding-action guide
204 Control unit
205 Position sensor
210 Braking element, mechanical braking element
211 Brake block
212 Energy-storage element, spring element, spring
220 Reset device
221 Brake-release device
222 Reset element
223 Motor
X₁ Defined rest position
X₂ Deflected position
dX Deflection during the course of the braking action

1-16. (canceled)

17. A brake device for an elevator system wherein a car is horizontally displaceable along a horizontal guide rail, the brake device being configured to brake a horizontal movement of the car in a first movement direction, wherein prior to a braking action of the horizontal movement of the car the brake device is disposed in a defined rest position relative to the horizontal guide rail, wherein the brake device is configured to be deflected into a deflected position during the braking action of the horizontal movement of the car, the brake device comprising a reset device configured to reset the brake device from the deflected position into the defined rest position following the braking action.

18. The brake device of claim 17 further comprising a braking element that applies a force to a braking rail.

19. The brake device of claim 18 wherein the braking element is configured as at least one of a mechanical braking element or an electromagnetic braking element.

20. The brake device of claim 18 wherein the braking element comprises an energy-storage element.

21. The brake device of claim 20 wherein the energy-storage element comprises a spring.

22. The brake device of claim 17 wherein the reset device comprises a brake-release device for releasing the brake device

23. The brake device of claim 17 wherein the reset device comprises at least one of a motor or an actuator for moving the brake device horizontally.

24. The brake device of claim 17 further comprising a control unit for controlling a resetting operation of the brake device.

25. The brake device of claim 17 further comprising a position sensor for determining a position of the brake device.

26. The brake device of claim 17 further comprising a bumper element.

27. The brake device of claim 17 further comprising a buffer element disposed at a car-end of the brake device.

28. The brake device of claim 17 disposed at a first end of the horizontal guide rail.

29. An elevator system comprising:
a horizontal guide rail;
a car that is horizontally displaceable along the horizontal guide rail; and
a brake device configured to brake a horizontal movement of the car in a first movement direction, wherein prior to a braking action of the horizontal movement of the car the brake device is disposed in a defined rest position relative to the horizontal guide rail, wherein the brake device is configured to be deflected into a deflected position during the braking action of the horizontal movement of the car, the brake device comprising a reset device configured to reset the brake device from the deflected position into the defined rest position following the braking action.

30. The elevator system of claim 29 wherein the brake device is a first brake device, the elevator system further comprising a second brake device, wherein the first brake device is configured to brake the horizontal movement of the car in the first movement direction and the second brake device is configured to brake the horizontal movement of the car in a second movement direction, wherein the first movement direction is directed counter to the second movement direction.

31. The elevator system of claim 30 wherein the first brake device and the second brake device are disposed at opposite ends of the horizontal guide rail.

32. The elevator system of claim 29 further comprising a linear drive that is configured to displace the car.

33. The elevator system of claim 29 further comprising at least two vertically-extending elevator shafts, wherein the car is displaceable between the at least two vertically-extending elevator shafts during a course of the horizontal movement.

34. The elevator system of claim 33 wherein a horizontal elevator shaft that contains the horizontal guide rail connects the at least two vertically-extending elevator shafts.
